(19) United States
(12) Patent Application Publication
(10) Pub. No.: US 2008/0285790 A1
(43) Pub. Date: Nov. 20, 2008

(54) GENERALIZED LOSSLESS DATA HIDING USING MULTIPLE PREDICTORS

(75) Inventors: Oscar Chi Lim Au, Kowloon (HK); Shu Kei Yip, Kowloon (HK)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: THE HONG KONG UNIVERSITY OF SCIENCE AND TECHNOLOGY, Kowloon (HK)

(21) Appl. No.: 11/750,591

(22) Filed: May 18, 2007

(51) Int. Cl. G06K 9/00

(52) U.S. Cl. 382/100

(57) ABSTRACT

A system and methodology for encoding or decoding hidden data, such as a digital watermark, in visual raster media is provided. The lossless data hiding methodology uses multiple predictors to choose an embedding location to be either a low variance region or a high variance region. Bijective mirror mapping is used to encode hidden data at an embedding location and bijective pixel value shifting is performed to ensure reversibility back to the original image without additional information. The system and methodology can be used either in the spatial domain or the wavelet domain. The Peak Signal to Noise Ratio and the payload capacity are relatively high with the methodology.

### TECHNICAL FIELD

The subject disclosure relates generally to data hiding in visual raster media, and more particularly to lossless encoding and decoding of hidden data, such as a digital watermark, using multiple predictor functions.

### BACKGROUND OF THE INVENTION

Steganography is the art and science of writing hidden messages in such a way that no one apart from the intended recipient knows of the existence of the message. For example, digital watermarking is one application of steganography. Digital watermarking is one of the ways to prove the ownership and the authenticity of the media. In order to enhance the security of the hidden message, the hidden message should be perceptually transparent and robustness. However, for hidden messages, there is a tradeoff between the visual quality and the payload. The higher the payload is, the lower the visual quality is.

In traditional watermarking algorithms, a digital watermark signal is embedded into a digital host signal resulting in watermarked signal. However, distortion is introduced into a host image during the embedding process and results in Peak Signal-to-Noise Ratio (PSNR) loss. Although the distortion is normally small, some applications, such as medical and military, are sensitive to embedding distortion and may not tolerate permanent loss of signal fidelity. As a result, lossless data hiding, which can recover the original host signal and/or the hidden data signal perfectly after extraction, is desirable for at least these applications.

There are a number of existing lossless/reversible watermarking algorithms. In one algorithm, modulo operations are used to ensure the reversibility, however, it often results in “salt-and-peppers” artifacts. In another algorithm, a circular interpretation of bijective transform is used for lossless watermarking. Although the algorithm can withstand some degree of image encoding (e.g., JPEG) attack, the small payload capacity and “salt-and-peppers” artifacts are major disadvantages of the algorithm. In yet another algorithm, the prediction error between the predicted pixel value and the original pixel value to embed data is used; however, some overhead (e.g., a location map and a threshold values) is needed to ensure the reversibility.

The above-described deficiencies of current data hiding methods are merely intended to provide an overview of some of the problems of today's data hiding techniques, and are not intended to be exhaustive. Other problems with the state of the art may become further apparent upon review of the description of various non-limiting embodiments of the invention that follows.

### SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

According to one aspect, a method of encoding/decoding hidden data is provided which uses a set of multiple predictors. Each predictor generates a predicted value for a pixel according to one or more surrounding pixels. The multiple predictor(s) can include, but is not limited to, a horizontal predictor, a vertical predictor, a casual weighted average, and a casual spatial varying weight. Data is embedded by making the watermarked pixel value close to one of the predicted values generated by the predictors. The embedding process involves bijective mirror mapping (BMM) for embedding hidden data and bijective pixel value shifting (BPVS) for maintaining reversibility of various candidate positions. By using different predictors, a candidate location can be either a low variance region (smooth region) or a high variance region (texture/edge region). The payload capacity is increased over the other methods, and no location map is needed to ensure the reversibility. In order to recover the watermark, some side information is conveyed to decoder, such as the set of predictors used.

To the accomplishment of the foregoing and related ends, certain illustrative aspects of the invention are described herein in connection with the following description and the annexed drawings. These aspects are indicative, however, of but a few of the various ways in which the principles of the invention may be employed and the present invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 is a schematic block diagram of an exemplary computer system operable to encode/decode hidden data, as well as present the visual image, whether containing the hidden data or not, to a content consumer.

FIG. 2 is a depiction of a visual image that may be encoded with hidden data and/or have hidden data decoded according to one embodiment.

FIGS. 3A-3E are illustrations of various predictors that may be used in accordance with an aspect of the present invention.

FIGS. 4A-4B illustrates the use of bijective mirror mapping (BMM) for embedding hidden data and bijective pixel value shifting (BPVS) for reversibility in accordance with an aspect of the present invention.

FIG. 5 is a schematic for determining in decoding whether BMM or BPVS was used on a particular pixel.

FIG. 6A-6C illustrate an example image to be encoded and where encoding takes place for small variance and large variance.

FIG. 7 illustrates an example system for encoding hidden data into visual media according to one embodiment.

FIG. 8 illustrates an exemplary method for encoding hidden data into visual media according to one embodiment.

FIG. 9 illustrates an exemplary method for decoding hidden data hidden in visual media according to one embodiment.

FIG. 10 is a schematic of a block based predictor.

FIG. 11 is a block diagram representing an exemplary non-limiting computing system or operating environment in which the present invention may be implemented.

### DETAILED DESCRIPTION OF THE INVENTION

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the terms “component,” “module,” “system”, or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

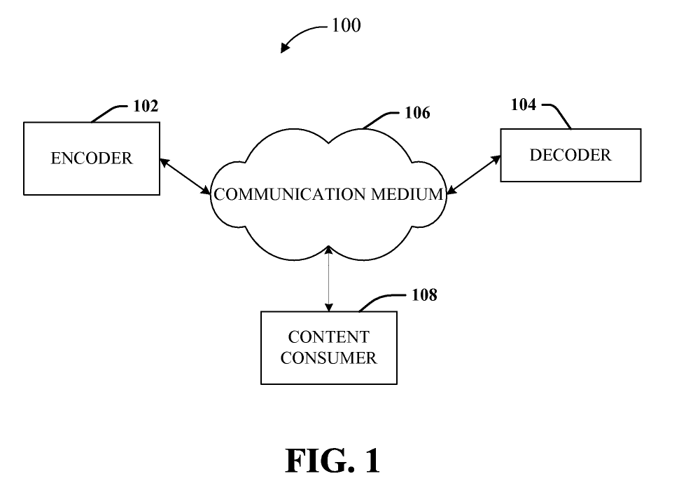

Referring now to FIG. 1, there is illustrated a schematic block diagram of an exemplary computer system operable to present visual media, encode, and decode hidden data. For the sake of clarity, only a single machine of each type is illustrated, but one skilled in the art will appreciate that there may be multiple machine of a given type and that some of the types may have their functionality distributed between more or less machines. The system 100 includes an encoder 102. The encoder 102 can be hardware and/or software (e.g., threads, processes, computing devices). In some embodiments, there are multiple encoders for each set of predictors and/or smooth/edge encoding regions. Selection of the appropriate encoder may be determined in some embodiments manually and the predictor set specified by a user. In other embodiments, the predictor set may be determined automatically and displayed to a user for use in decoding the hidden data, such as the digital watermark.

The system 100 also includes a decoder 104. The decoder 104 can also be hardware and/or software (e.g., threads, processes, computing devices). The decoder 104 can house threads to perform decoding. Multiple decoders for each set of predictors and/or smooth/edge encoding regions. One possible communication between an encoder 102 and a decoder 104 can be in the form of data packets adapted to be transmitted between two or more computer processes. The data packets can include data representing visual media, such as a video frame or a static image.

The system 100 also includes a content consumer 108. The content consumer can also be hardware and/or software (e.g., threads, processes, computing devices). The content consumer 108 can present the visual media to a user and/or store the visual media for future distribution and/or playback. In some embodiments, the content consumer and/or its user is aware of the hidden data. For example, media companies may indicate that particular visual media is watermarked to deter unauthorized copying. In a second example, the content presenter 108 and decoder 104 are executing on the same machine and that machine verifies authenticity before presenting the visual media to the user. In other embodiments, the content consumer 108 is unaware of the hidden data such as when the hidden data is not a digital watermark but instead a hidden message.

The system 100 includes a communication framework 106 (e.g., a global communication network such as the Internet; or a more traditional computer-readable storage medium such as a tape, DVD, flash memory, hard drive, etc.) that can be employed to facilitate visual media communications between the encoder 102, decoder 104 and content consumer 108. Communications can be facilitated via a wired (including optical fiber) and/or wireless technology and via a packet-switched or circuit-switched network.

For the sake of simplicity and clarity, an embodiment involving a 256 shades greyscale image, a set of only two predictors, and a digital watermark as the hidden data are described as used in an exemplary embodiment. However, one will appreciate that the techniques may be applied to multiple colors, multiple color depths, more than two predictors, and frames within a video. In addition, one will appreciate that the methodology may be performed at a block level instead of the pixel level.

According to one embodiment, the system and methodology performs data hiding in raster scan order. A predictor generates a predicted value for a pixel based on the surrounding pixels. Different predictors with different characteristics, such as edge preserving, noise removal, edge sensitive and so on, usually result in different predicted pixel values. By examining the predicted pixel values, candidate locations for embedding regions can be determined. After defining the embedding location (e.g., smooth (or small difference in predicted values); and edge (or large difference in predicted values), bijective mirror mapping is used to embed the digital watermark by choosing the watermarked pixel value to be closest to one of those predicted pixel values. In the case of a set of two predictors, the watermarked pixel will be either closer to the minimum or the maximum of these two predicted values. In the case of a set of three or more predictors, the watermarked pixel can still be the minimum or the maximum of the three predicted values.

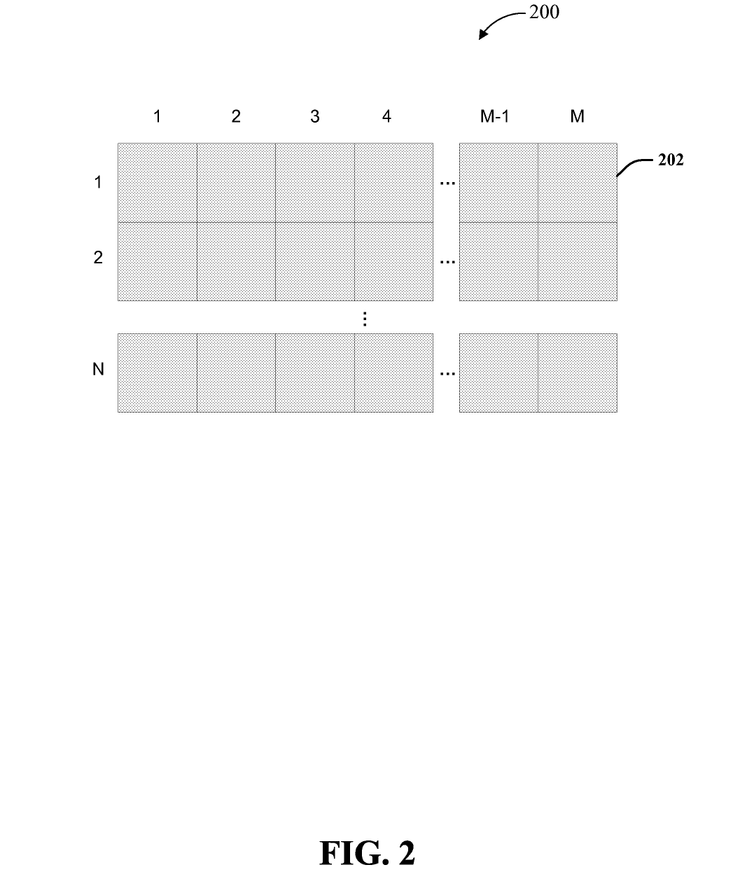

Referring to FIG. 2, the original host image is denoted as P 200 and has a size of M×N. The pixel 202 value of P is P(x,y), for x=1 . . . M and y=1 . . . N. The binary watermark L can have the same or smaller size than P. Using two predictors as a simple example, \hat{P}₁(x, y) is the predicted pixel value from predictor 1, and \hat{P}₂(x, y) is the predicted pixel value from predictor 2. The watermarked image is denoted as Q.

The method according to one embodiment starts by setting Q equal to P. In one exemplary embodiment, the first row and the first column is not be used for embedding, as it is needed for prediction. However, depending on a particular application, other rows or columns can also not be used for potential embedding. For example, if one of the predictor used needs additional pixel values to predict a value, other rows and columns may not be usable for embedding. Similarly, if the unit of the visual media worked on is a block instead of a pixel, only even rows may be potentially used for embedding. As a final example, if protection from a crop attack is desired, a row in the center of the visual media can be used to synchronize the predicted values and not used for potential embedding.

Before the embedding process, encoder users choose which set of predictors are used—the decoder uses the same set of predictor as the encoder—as well as other configuration settings discussed below (e.g., the range R, the value of B, embedding domain, and mapping function). In the process of choosing the set of predictor used, the encoder user also selects how many predictors are to be taken into account. Default values can be used for at least some of the other configuration settings not specified by the encoder user.

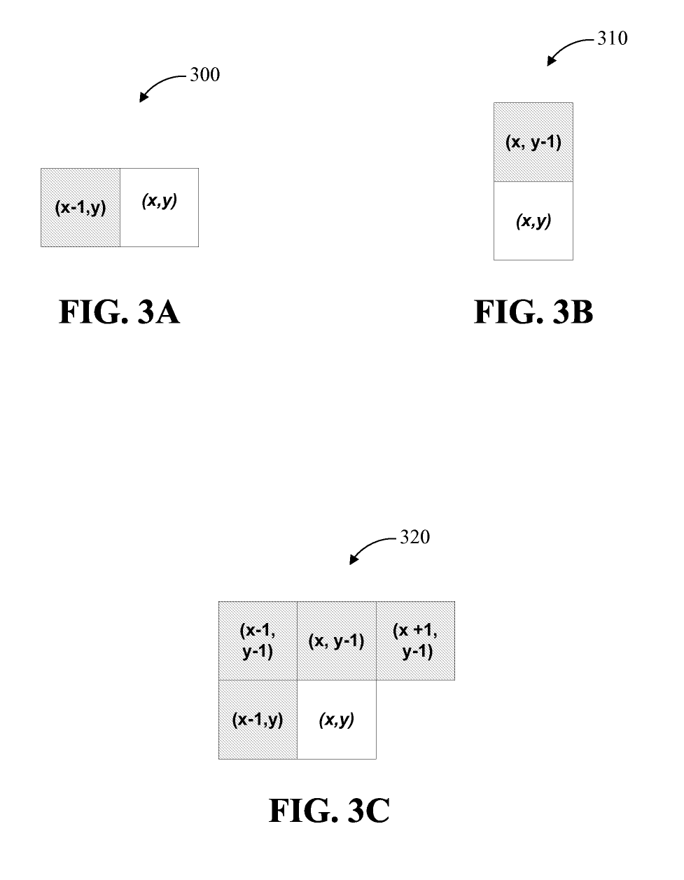

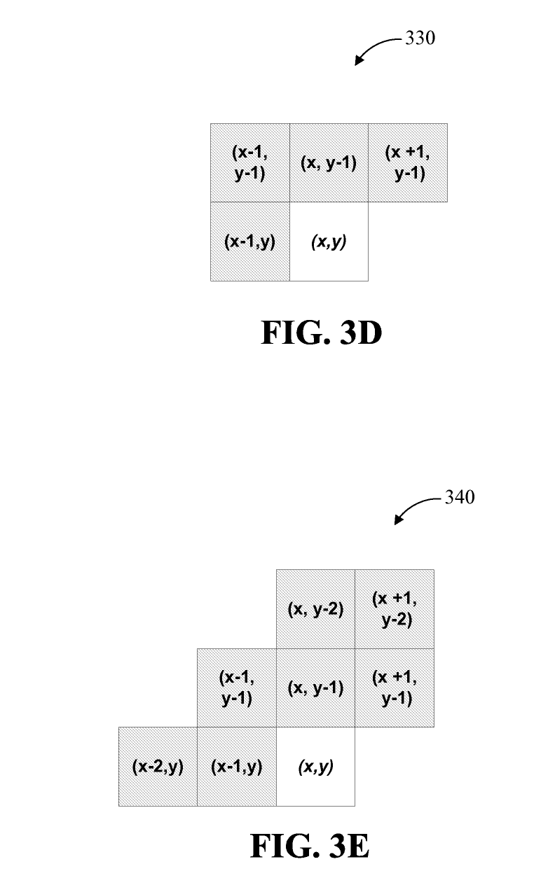

A non-exclusive list of potential predictors is shown below and the pixels used as part of the predictors are illustrated in FIG. 3A-3E.:

Horizontal Predictor: \hat{P}(x,y)=Q(x−1,y) (300 of FIG. 3A)

Vertical Predictor: \hat{P}(x, y)=Q(x, y−1) (310 of FIG. 3B))

Causal Weighted Average: \hat{P}(x, y)=(2×Q(x−1, y)+2×Q(x, y−1)+Q(x−1, y−1)+Q(x+1, y−1))/6 (320 of FIG. 3C))

Causal Average: \hat{P}_{x,y}=(Q(x−1, y)+Q(x, y−1)+Q(x−1, y−1)+Q(x+1, y−1))/4 (330 of FIG. 3D)

Causal Spatial Varying Weight (SVF): Before applying casual SVF, a “target” value, Tgtx,y, is computed by calculating the casual average of the neighboring pixels, Q(x−1, y), Q(x, y−1), Q(x+1, y−1) and Q(x−1, y−1). The locations of four candidate pixels are shown in 330 of FIG. 3D.

However, using the mean method to determine the “target” value is often not representative enough, especially in the casual case, as mean algorithm will be affected by outliers. As a result, activity measurement can be used instead. The locations of pixels involved in activity measurement are shown in 340 of FIG. 3E.

The equations involved in activity measurement are:

dₕ=|Q(x−2,y)−Q(x−1,y)|+|Q(x−1,y−1)−Q(x,y−1)|+|Q(x,y−1)−Q(x+1,y−1)| Eqn. A

dᵥ=|Q(x−1,y−1)−Q(x−1,y)|+|Q(x,y−2)−Q(x,y−1)|+|Q(x+1,y−2)−Q(x+1,y−1)| Eqn. B

The value of dₕ and dᵥ are the activity in horizontal direction and vertical direction respectively. The higher the activity value is, the less the correlation between pixel in that direction is. If dₕ<dᵥ, the value of Tgtx,y is set to Q(x−1,y). If dₕ>dᵥ, the value of Tgtx,y is set to Q(x,y−1).

By using Tgt_{x,y}, the predicted pixel value at (x, y), \hat{P} x,y, can be computed by refining the Tgt_{x,y} using the neighboring candidate pixels, Q(x−1, y), Q(x,y−1), Q(x+1, y−1) and Q(x−1, y−1) through SVF.

$${\hat{P}}_{( x , y )} = \frac{{\sum }_{n = - 1}^{1} {Q}_{( x - n , y - 1 )} {W}_{x - n , y - 1} + {Q}_{( x - 1 , y )} {W}_{x - 1 , y}}{{\sum }_{n = - 1}^{1} {W}_{x - n , y - 1} + {W}_{x - 1 , y}} \qquad Eqn . C$$

The spatial varying weight, W_{i,j} can be any monotonic decreasing function. The W_{i,j} is negatively correlated with D_{i,j}, which is the difference between the neighboring pixel values and the Tgt_{x,y}. The value of D_{i,j} and W_{i,j} is calculated as follows:

D_{i,j}=|Q(x+i,y+j)−Tgt_{x,y}| Eqn. D

W_{i,j}=exp (−D_{i,j}·k) Eqn. E

k is the controlling factor which controls suppression degree of outliers. For determining W_{i,j}, Equation E is used. Casual SVF will predict the pixel value by suppressing the outlier with a lower W_{i,j}.

For every pixel, P(x,y), the minimum predicted value of these 2 predictors is denoted as min_P and the maximum predicted value is denoted as max_P.

min_{—}P=min(\hat{P}₁(x, y), \hat{P}₂(x, y)) Eqn. 1

max_{—}P=max(\hat{P}₁(x, y), \hat{P}₂(x, y)) Eqn. 2

The difference between two predictor is, Diff_P.

Diff_{—}P=max_{—}P−min_{—}P−1 Eqn. 3

Encoder users can choose in advanced to embed the watermark in the region with large Diff_P or small Diff_P. However, in other embodiments, the region of encoding can be determined automatically based on the image (e.g., choosing the region to maximize payload). If the predictor pair is causal SVF and weighted average, or horizontal predictor and vertical predictor, larger Diff_P means the region with higher variance. As for smooth region, both predictors can predict well and get the similar predicted values, however, for the edge or texture region, one of the predictors will get a closer value whereas the other predictor will get a less accurate predicted value. On the other hand, the larger the Diff_P is, the larger the watermark strength is.

In order to become one of the possible candidates to embed 1 bit of watermark, the predicted pixel values should satisfy the following conditions:

Region Condition: Diff_P is in a predefined range, R a)

Minimum Condition: min_{—}P>floor(1.5R)+1+B b)

Maximum Condition: max_{—}P<255−floor(1.5R)−1−B c)

where B is the predefined value to make sure the watermarked pixel value is in between 0 and 255.

In at least one embodiment, B can be tuned iteratively, and the minimum value of B, Bₘᵢₙ, can be found. When the value of B is increased larger than Bₘᵢₙ, the number of candidate positions decrease and thus the payload decreases. The value of Bₘᵢₙ depends on the characteristics of the image. If the image is a low-variance image, the value of Bₘᵢₙ is smaller. Conversely, if the image is a high-variance image, the value of Bₘᵢₙ is larger. The value of B can be treated as a unique key that is used to have perfect reconstruction of the watermark and recovery of the host image. An encoder user can choose any value larger than Bₘᵢₙ (and less than 255) to enhance the security of the watermark.

To prevent a great distortion, some candidate positions are used for watermarking by performing bijective mirror mapping (BMM) and some candidate positions are used to ensure the reversibility by performing bijective pixel value shifting (BPVS). The candidate position is used for watermarking if the position satisfies the following requirement:

Embedding Condition: min_{—}P−floor(0.5Diff_{—}P)<P(x,y)<max_{—}P+floor(0.5Diff_{—}P) d)

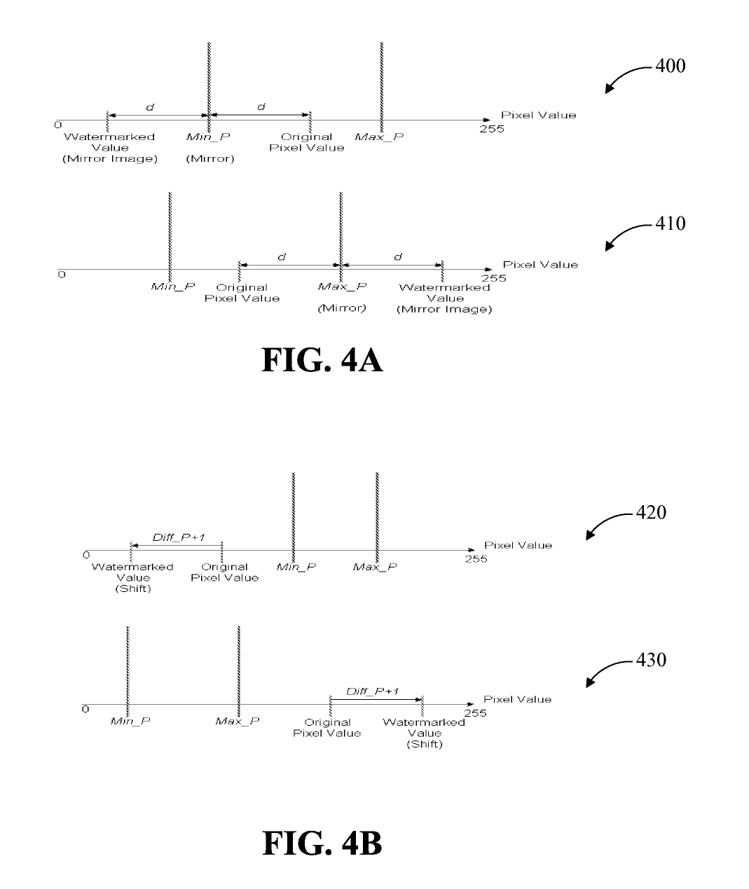

BMM is performed for the candidate positions which satisfy the condition (d). Min_P and Max_P will be selected as “mirror” according to the watermark bit. For example, if L(x, y) is “1” (“0”), Min_P (Max_P) will be chosen as “mirror”. The BMM is illustrated in FIG. 4A. When L(x,y) is one, the top 400 is used to encode the value of one. Conversely, when L(x,y) is zero, the bottom 410 is used to encode the value of zero.

For the candidate positions that do not satisfy the condition (d), BPVS is performed in order to ensure the reversibility. The BPVS process is illustrated in FIG. 4B (420 and 430). By shifting with pixel value of Diff_P+1, the watermark can be extracted without confusion.

The watermarked image, Q, is formed after performing BMM or BPVS.

In the watermark extraction and image recovery, the same set of predictors and variable values (R and B), are used with inverse raster scan order. In one embodiment, this additional information can be transmitted with the watermarked image or separately supplied (e.g., by out of band transmission to a decoder). By computing the condition (a), (b) and (c), candidate positions are identified.

Extraction Condition: min_{—}P−floor(1.5Diff_{—}P)−1<S(x,y)<max_{—}P+floor(1.5Diff_{—}P)+1 e)

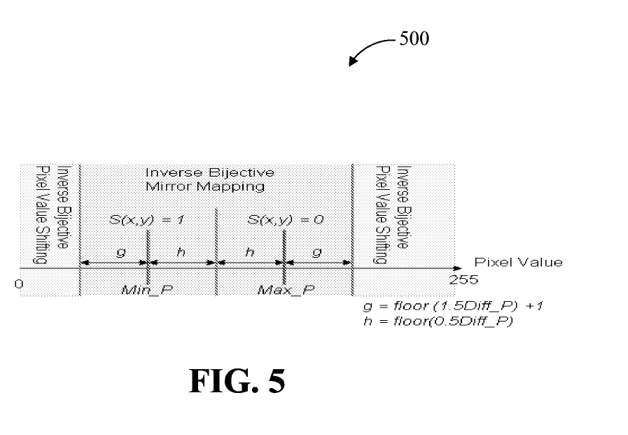

For those candidate positions which satisfy condition (e), the watermark is extracted by comparing the difference between the received watermarked pixel values with each predicted values. If the received watermarked pixel values are closer to Min_P (Max_P), the extracted watermark value is set to “1” (“0”). The extracted watermark, S, and process 500 of determining it is illustrated in FIG. 5. The watermarked image can be converted to the host image perfectly by performing inverse-BMM or inverse-BPVS according to condition e).

Referring to FIG. 5, in order to eliminate the confusion in watermark extraction, h should be limited to floor(0.5Diff_P), and hence why condition d) is set. By condition d), the maximum change due to BMM is floor(1.5R)+1 and therefore condition b), c) and e) are set.

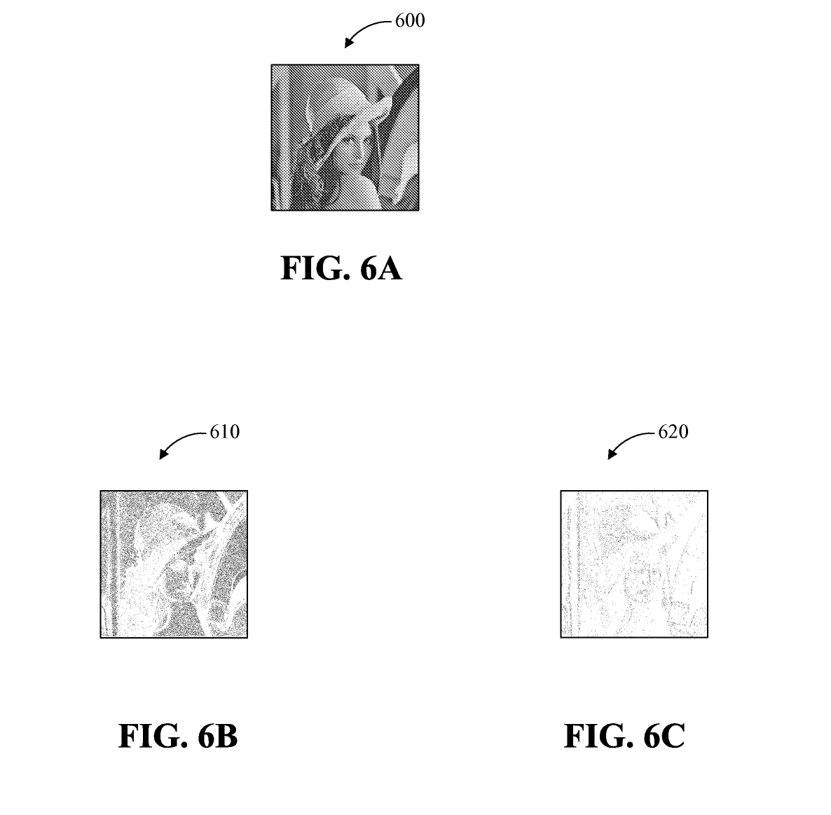

The data hiding algorithm according to one aspect of the present invention was tested with several standard testing images available from the USC-SIPI image database. The tested images are Lena, Barbara, F16, Pentagon, and Peppers. Each were tested with an image size of 512×512 pixels. FIG. 6A shows the original Lena image 600. The embedding locations on the Lena image 600 for the predictor pair, horizontal predictor and vertical predictor, with small Diff_P 610 and large Diff_P 620 are shown in FIG. 6B and FIG. 6C, respectively. The black dots mean the location with watermark embedding whereas the white dots mean the location without embedding.

Referring to FIG. 6B, smaller Diff_P means embedding is in the smooth region of the image whereas larger Diff_P (as shown in FIG. 6C) means embedding in the edge region. In the smooth region, both the predetermined horizontal and vertical predictors can predict well, however, for the edge or texture region, the predicted values will be quite different.

The Peak Signal-to-Noise Ratio (PSNR) and the Weighted PSNR (WPSNR) between the watermarked image and the original host image are used for measurement of visual quality. WPSNR is based on the Contrast Sensitive Function (CSF) of Human Visual System. The PSNR and the WPSNR and the payload are shown in table I and II. For table I and II, small Diff_P is used as well as a constant value of B, which is greater than the Bₘᵢₙ of all the images. For table I, the predictor pair—causal weighted average and causal SVF is used. For table II, the predictor pair—horizontal predictor and vertical predictor is used.

TABLE I
PERFORMANCE OF DIFFERENT IMAGES - CAUSAL
WEIGHTED AVERAGE AND CAUSAL SVF

| | Payload | PSNR | WPSNR |
|---|---|---|---|
| Images | (bpp) | (dB) | (dB) |
| Lena | 0.199 | 38.76 | 53.52 |
| Barbara | 0.152 | 39.79 | 54.57 |
| F16 | 0.167 | 39.70 | 54.48 |
| Pentagon | 0.096 | 40.52 | 55.89 |
| Peppers | 0.101 | 40.65 | 55.78 |

TABLE II
PERFORMANCE OF DIFFERENT IMAGES - HORIZONTAL
PREDICTOR AND VERTICAL PREDICTOR

| | Payload | PSNR | WPSNR |
|---|---|---|---|
| Images | (bpp) | (dB) | (dB) |
| Lena | 0.044 | 46.19 | 61.24 |
| Barbara | 0.033 | 47.48 | 62.39 |
| F16 | 0.033 | 47.63 | 62.59 |
| Pentagon | 0.015 | 48.93 | 64.03 |
| Peppers | 0.019 | 47.46 | 62.59 |

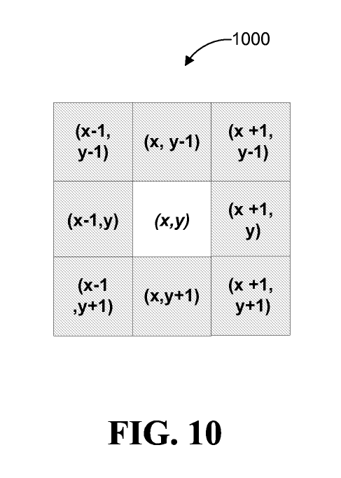

According to the exemplary embodiment, causal neighborhood is used, which is shown in FIG. 3A-3E. In order to enhance the accuracy of the predicted values, overlapped non-causal neighborhood can be used, which is shown according to an example non-casual predictor 1000 in FIG. 10. When the predictor 1000 is used, the even-even location is checked to determine if it is suitable for embedding whereas the other location is used for prediction only. By changing to non-causal neighborhood (block based), the PSNR increases as the accuracy of the predicted pixel values increase, however, payload will be decreased.

In order to increase the payload and embed the information bit in a constant intensity region, predictor expansion can be used. For a constant intensity region, both predictors will normally result in the similar or same value. In order to become candidate position, Diff_P should be lager than 2 for binary watermark. The payload is increased by increasing Max_P with a constant, c₁, and/or decreasing the Min_P with c₂, so it can hide more data by increasing the number of candidate position.

Predictor expansion was tested as well. In table III, both predictors are causal SVF and the technique of predictor expansion is used.

TABLE III
PSNR AND WPSNR OF DIFFERENT IMAGES - CAUSAL
SVF ONLY

| | Payload | PSNR | WPSNR |
|---|---|---|---|
| Images | (bpp) | (dB) | (dB) |
| Lena | 0.407 | 34.91 | 48.76 |
| Barbara | 0.315 | 35.24 | 49.59 |
| F16 | 0.324 | 35.84 | 49.05 |
| Pentagon | 0.283 | 35.00 | 50.35 |
| Peppers | 0.306 | 35.24 | 50.54 |

The system can also be extended to prevent a cropping attack by inserting the synchronization code into the hidden data signal. The region of inserting the synchronization code is predefined (e.g., near the center of the host image). When the predictors are casual and with small neighborhood, the predicted value depends on the neighboring pixels only. The watermark can still be extracted and noticeable. By using the extracted synchronization code, at least some of the hidden data can be reconstructed even after cropping.

As previously mentioned, the system and methodology can be extended using more than two predictors. For example, if a third predictor is used, candidate locations using a small Diff_P can be determined using either the middle predicted value and the minimum predicted value or the middle predicted value and the maximum predicted values. Similarly, candidate positions using a large Diff_P can be determined using the maximum and the minimum predicted values from the set of predicted values. As a result, a higher PSNR can be achieved. As another example, if four predictors are used, payload can be increased as a single embedding location can contain two bits of information, instead of one.

One will appreciate that various other modification can be made in other embodiments. For example, one will appreciate that other mapping functions well known in the art can be used instead of bijective mirror mapping. In addition, although the system and methodology have been described as occurring in the spatial domain, the techniques may be applied to coefficients after an image transformation has occurred. For example, in another embodiment, the techniques are used in the wavelet domain. After transforming the original image using wavelet transform, the host image is decomposed into different sub-bands (LL, LH, HL, HH), where L stands for lowpass and H stands for highpass. The HH sub-band can be used for embedding hidden data since the Human Visual System (HVS) is less sensitive to changes in the HH sub-band. A set of predictors is then used to predict the wavelet coefficient based on neighboring wavelet coefficients. BMM and BPVS can be subsequently used if the appropriate conditions are satisfied, just as in the spatial domain.

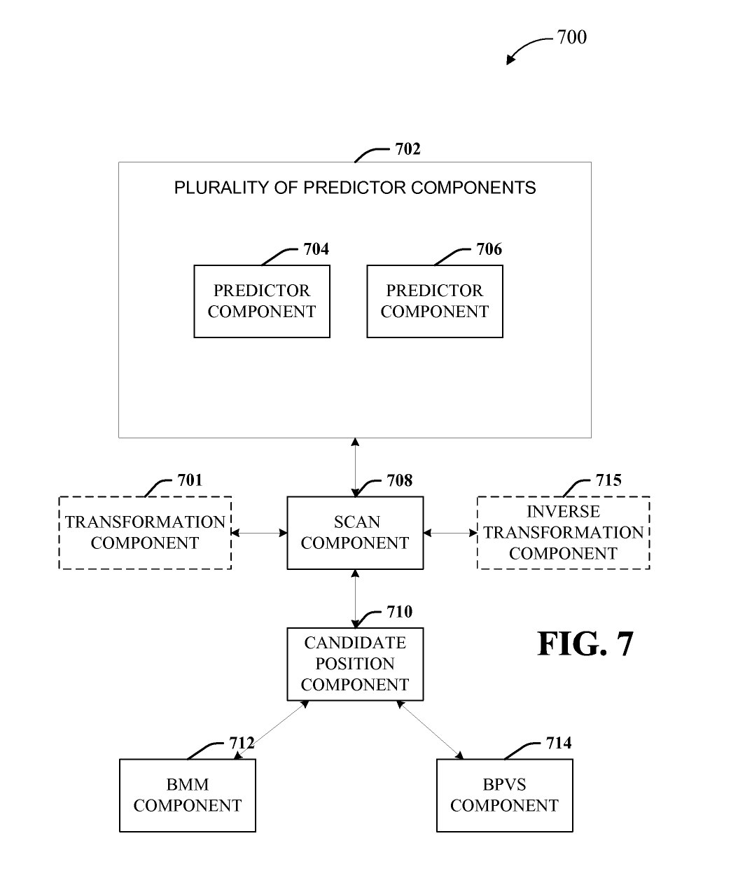

Referring to FIG. 7, a system 700 for encoding hidden data is illustrated. The scan component 708 scans through at least some of the pixels of the raster image. During the scan, a plurality 702 of predictor components (e.g., 704, 706) are invoked, which each determine a predicted value for a pixel according to one or prediction formula. Although only two are shown, additional predictor components may be present in the system. After obtaining the predicted values, the candidate position component 710 is called to determine if the pixel is a candidate position based at least in part on the difference between the predicted values obtained from the predictor components. If the pixel is determined to be candidate position, the BMM component 712 or the BPVS component is called based on whether condition (d) is met. If condition (d) is met, then the BMM component 712 is called to embed at least one bit of hidden data using bijective mirror mapping. If the pixel is a candidate position but condition (d) is not met, then the BPVS component 714 is called to alter the pixel value using bijective pixel value shifting. If the pixel is not a candidate position, the pixel value is left unchanged.

In an alternative embodiment, the original image is transformed using the transformation component 701. The transformation component, for example, can transform the image using wavelet transform. After transforming the image, the scan component 708 can be used to scan at least some of the coefficients. Other than using coefficients instead of pixels, the other components (704, 706, 710, 712, 714) perform the same basic functionality as described above. An inverse transformation component 715 is utilized at the end of the scan to produce the image containing the hidden data.

Although not shown, a decoding system would be similar. The BMM component and the BPVS component would be replaced with an inverse BMM component and an inverse BPVS component, respectively. Each of these components would perform the inverse operation of their respective component. In addition, the scan component would instead perform an inverse scan by scanning in an order opposite the original scan.

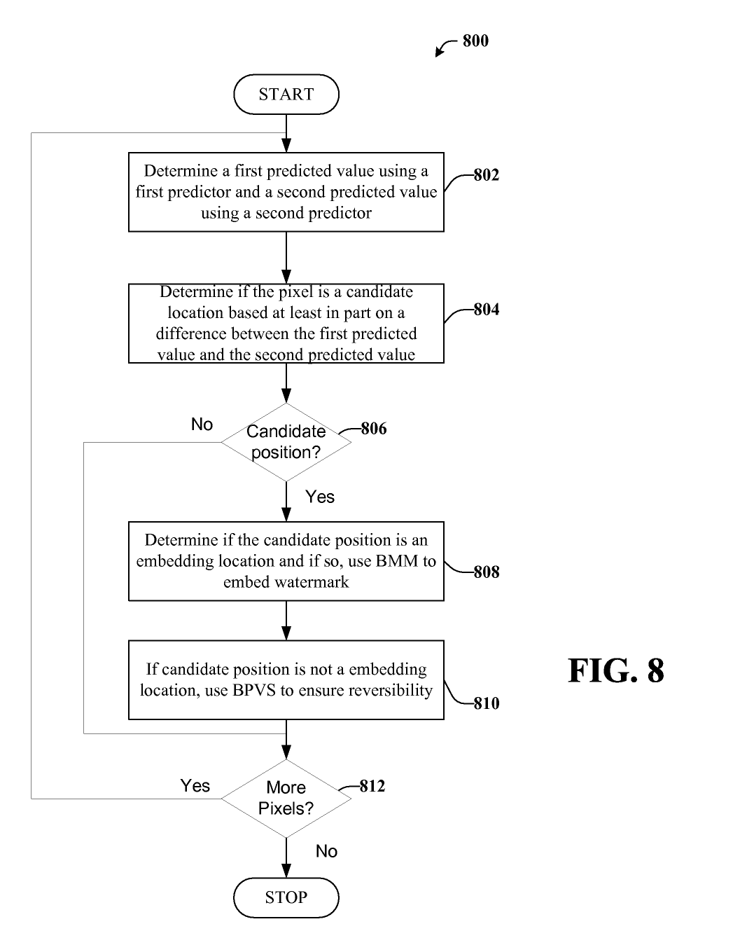

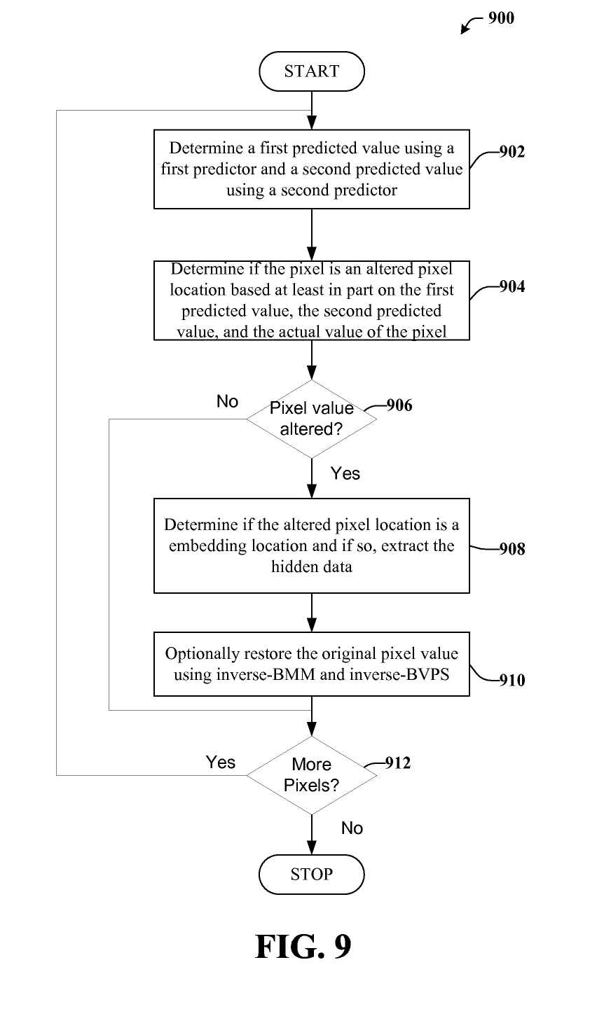

FIGS. 8 and 9 illustrate various methodologies in accordance with one embodiment. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media. Furthermore, it should be appreciated that although for the sake of simplicity an exemplary method is shown for use with a single color value for a pixel, the method may be performed for multiple color values.

Referring to FIG. 8, an example method 800 for encoding hidden data, such as a digital watermark, in visual raster media according to one embodiment is illustrated. At 802, a first predicted value is determined using a first predictor and a second predicted value is determined using a second predictor. At 804, it is determined whether the pixel is a candidate location based at least in part on the difference between the first and second predicted value. At 806, if the pixel is not a candidate location, flow proceeds to 812 and the pixel value is left unchanged. At 808, it is determined if the candidate position is an embedding location, such as based on whether condition d) is met. If so, bijective mirror mapping is used to alter the value of the pixel. If not, at 810, bijective pixel value shifting is used to ensure reversibility without additional data. At 812, it is determined if there are more pixels to scan for potential candidate positions. If so, flow returns to 802 for the next pixel to scan.

Referring to FIG. 9, an example method 900 for decoding the hidden data in visual raster media according to one embodiment is illustrated. The method is performed in an inverse scan to that performed by the method shown in FIG. 8. At 902, a first predicted value is determined using a first predictor and a second predicted value is determined using a second predictor. At 904, it is determined whether the pixel is an altered pixel location based at least in part on the first and second predicted values and the actual pixel value. At 906, if the pixel is not an altered pixel location, flow proceeds to 912. At 908, it is determined if the altered pixel location is an embedding location. If so, the hidden data is extracted. At 910, inverse bijective pixel value shifting and/or inverse bijective mirror mapping is optionally used to restore the original pixel value. At 912, it is determined if there are more pixels to scan for potential altered pixel locations. If so, flow returns to 902 for the next pixel to scan.

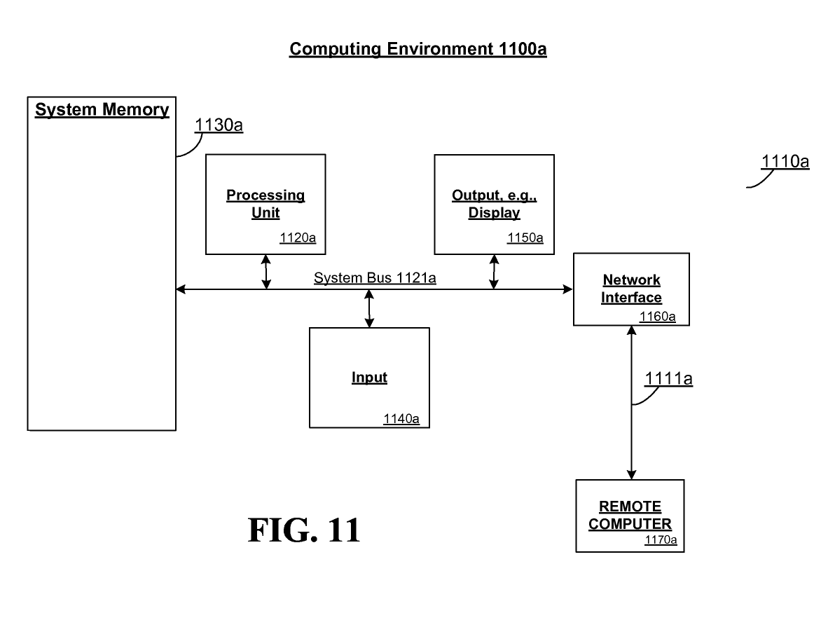

Turning now to FIG. 11, an exemplary non-limiting computing system or operating environment in which the present invention may be implemented is illustrated. Handheld, portable and other computing devices and computing objects of all kinds are contemplated for use in connection with the present invention, i.e., anywhere that visual media is presented, distributed from, or forensically analyzed. Accordingly, the below general purpose remote computer described below in FIG. 11 is but one example of a computing system in which the present invention may be implemented.

Although not required, the invention can partly be implemented via an operating system, for use by a developer of services for a device or object, and/or included within application software that operates in connection with the component(s) of the invention. Software may be described in the general context of computer-executable instructions, such as program modules, being executed by one or more computers, such as client workstations, servers or other devices. Those skilled in the art will appreciate that the invention may be practiced with other computer system configurations and protocols.

FIG. 11 thus illustrates an example of a suitable computing system environment 1100a in which the invention may be implemented, although as made clear above, the computing system environment 1100a is only one example of a suitable computing environment for a media device and is not intended to suggest any limitation as to the scope of use or functionality of the invention. Neither should the computing environment 1100a be interpreted as having any dependency or requirement relating to any one or combination of components illustrated in the exemplary operating environment 1100a.

With reference to FIG. 11, an example of a remote device for implementing the invention includes a general purpose computing device in the form of a computer 1110a. Components of computer 1110a may include, but are not limited to, a processing unit 1120a, a system memory 1130a, and a system bus 1121a that couples various system components including the system memory to the processing unit 1120a. The system bus 1121a may be any of several types of bus structures including a memory bus or memory controller, a peripheral bus, and a local bus using any of a variety of bus architectures.

Computer 1110a typically includes a variety of computer readable media. Computer readable media can be any available media that can be accessed by computer 1110a. By way of example, and not limitation, computer readable media may comprise computer storage media and communication media. Computer storage media includes volatile and nonvolatile as well as removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 1110a. Communication media typically embodies computer readable instructions, data structures, program modules or other data in a modulated data signal such as a carrier wave or other transport mechanism and includes any information delivery media.

The system memory 1130a may include computer storage media in the form of volatile and/or nonvolatile memory such as read only memory (ROM) and/or random access memory (RAM). A basic input/output system (BIOS), containing the basic routines that help to transfer information between elements within computer 1110a, such as during start-up, may be stored in memory 1130a. Memory 1130a typically also contains data and/or program modules that are immediately accessible to and/or presently being operated on by processing unit 1120a. By way of example, and not limitation, memory 1130a may also include an operating system, application programs, other program modules, and program data.

The computer 1110a may also include other removable/non-removable, volatile/nonvolatile computer storage media. For example, computer 1110a could include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive is typically connected to the system bus 1121a through a non-removable memory interface such as an interface, and a magnetic disk drive or optical disk drive is typically connected to the system bus 1121a by a removable memory interface, such as an interface.

A user may enter commands and information into the computer 1110a through input devices such as a keyboard and pointing device, commonly referred to as a mouse, trackball or touch pad. Other input devices may include a microphone, joystick, game pad, satellite dish, scanner, or the like. These and other input devices are often connected to the processing unit 1120a through user input 1140a and associated interface(s) that are coupled to the system bus 1121a, but may be connected by other interface and bus structures, such as a parallel port, game port or a universal serial bus (USB). A graphics subsystem may also be connected to the system bus 1121a. A monitor or other type of display device is also connected to the system bus 1121a via an interface, such as output interface 1150a, which may in turn communicate with video memory. In addition to a monitor, computers may also include other peripheral output devices such as speakers and a printer, which may be connected through output interface 1150a.

The computer 1110a may operate in a networked or distributed environment using logical connections to one or more other remote computers, such as remote computer 1110a, which may in turn have media capabilities different from device 1110a. The remote computer 1170a may be a personal computer, a server, a router, a network PC, a peer device or other common network node, or any other remote media consumption or transmission device, and may include any or all of the elements described above relative to the computer 1110a. The logical connections depicted in FIG. 11 include a network 1111a, such local area network (LAN) or a wide area network (WAN), but may also include other networks/buses. Such networking environments are commonplace in homes, offices, enterprise-wide computer networks, intranets and the Internet.

When used in a LAN networking environment, the computer 1110a is connected to the LAN 1111a through a network interface or adapter. When used in a WAN networking environment, the computer 1110a typically includes a communications component, such as a modem, or other means for establishing communications over the WAN, such as the Internet. A communications component, such as a modem, which may be internal or external, may be connected to the system bus 1121a via the user input interface of input 1140a, or other appropriate mechanism. In a networked environment, program modules depicted relative to the computer 1110a, or portions thereof, may be stored in a remote memory storage device. It will be appreciated that the network connections shown and described are exemplary and other means of establishing a communications link between the computers may be used.

The present invention has been described herein by way of examples. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

Various implementations of the invention described herein may have aspects that are wholly in hardware, partly in hardware and partly in software, as well as in software. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device.

Furthermore, the invention may be described in the general context of computer-executable instructions, such as program modules, executed by one or more components. Generally, program modules include routines, programs, objects, data structures, etc. that perform particular tasks or implement particular abstract data types. Typically the functionality of the program modules may be combined or distributed as desired in various embodiments. Furthermore, as will be appreciated various portions of the disclosed systems above and methods below may include or consist of sub-components, processes, means, methodologies, or mechanisms.

Additionally, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The terms “article of manufacture,” “computer program product” or similar terms, where used herein, are intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components, e.g., according to a hierarchical arrangement. Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

What is claimed is:

1. A method of data hiding for raster images, comprising:
for each pixel of at least two pixels of an original raster image,
determining a first predicted value for the pixel based on a first predictor;
determining a second predicted value for the pixel based on a second predictor;
determining if the pixel is a candidate position based at least in part on a difference between the first predicted value and the second predicted value; and
if the pixel is a candidate position,
encoding at least one hidden bit using bijective mirror mapping; or
using bijective pixel value shifting to ensure reversibility back to the original raster image when decoded.

2. The method of claim 1, wherein the encoding includes encoding at least one digital watermark.

3. The method of claim 1, wherein the determining if the pixel is a candidate position includes determining if the pixel is a high variance region.

4. The method of claim 1, wherein the determining if the pixel is a candidate position includes determining if the pixel is a low variance region.

5. The method of claim 1, wherein the first predictor and the second predictor are the same predictor and wherein the determining of the candidate position based at least in part on a difference between the first predicted value and the second predicted value includes determining an embedding location based at least in part on a difference between the first predicted value and the second predicted value plus or minus a predetermined constant.

6. The method of claim 1, wherein the encoding includes encoding at least one hidden bit using bijective mirror mapping when the value of the pixel is within a range of a pre-defined function of the first predicted value and the second predicted value.

7. The method of claim 1, wherein at least one of the determining a first predicted value for the pixel based on a first predictor or the determining of the second predicted value for the pixel based on a second predictor includes determining a value for the pixel based on a casual neighborhood.

8. The method of claim 1, wherein the at least two pixels of the original raster image includes all pixels of the original raster image except for the first row of the original raster image and the first column of the original raster image.

9. The method of claim 1, further comprising:
receiving an indication of the first predictor and the second predictor.

10. The method of claim 1, further comprising:
for each pixel of at least two pixels of an original raster image,
determining a third predicted value for the pixel based on a third predictor;
determining a fourth predicted value for the pixel based on a fourth predictor; and
determining if the pixel is a candidate position based at least in part on a difference between the third predicted value and the fourth predicted value.

11. A computer-readable medium containing computer-executable operations for performing the method of claim 1.

12. A digital watermarking system comprising:
a plurality of predictor components, each predictor component configured to determine a predicted value of a unit of a raster image;
a bijective mirror mapping component configured to embed hidden data in the raster image by using bijective mirror mapping;
a bijective pixel value shifting component configured to use bijective pixel value shifting to ensure reversibility back to the raster image without hidden data;
a candidate position component configured to determine candidate positions based at least in part on the difference between predicted values determined by the plurality of predictor components; and
a scan component configured to scan each of at least two units of the raster image.

13. The system of claim 12, wherein the unit is a coefficient and further comprising a transformation component configured to perform wavelet transform on the raster image.

14. A method of recovering a digital watermark in a raster image, comprising:
for each of at least two units of a watermarked raster image,
determining a first predicted value for the unit based on a first predictor;
determining a second predicted value for the unit based on a second predictor;
determining if the unit is an altered unit location based at least in part on the first predicted value, the second predicted value, and an actual value of the unit; and
when the unit is an altered unit location,
determining if the altered unit location is an embedding location; and
extracting at least one watermark bit if the altered unit location is an embedding location.

15. The method of claim 14, further comprising:
receiving an indication of the first predictor, the second predictor, and one or more variables used in determining if the altered unit location is an embedding location.

16. The method of claim 14 wherein the unit is a pixel.

17. The method of claim 14, further comprising:
if the unit is an altered pixel location,
using inverse bijective mirror mapping if the altered unit location is an embedding location; and
using inverse bijective pixel value shifting if the altered unit location is not an embedding location.

18. The method of claim 14, further comprising:
indicating whether the at least one extracted watermark bit matches at least one predetermined watermark bit.

19. The method of claim 14, wherein the determining if the altered unit location is an embedding location includes determining whether the actual unit value is less than a result of applying a pre-defined function to a difference between the first predicted value and the second predicted value.

20. A computer-readable medium containing computer-executable operations for performing the method of claim 14.
